(19) United States
(12) Patent Application Publication
(10) Pub. No.: US 2012/0102107 A1
(43) Pub. Date: Apr. 26, 2012

(54) "EYE TO EYE" SYSTEM (121): CONTACT APPARATUS OPERATING AS PORTABLE AND MOBILE MEETING SITE

(76) Inventor: Patrick Serge Parent, La Roche-en-Ardenne (BE)

(21) Appl. No.: 13/058,531

(22) PCT Filed: Aug. 7, 2009
(86) PCT No.: PCT/BE09/00043

§ 371 Date: Feb. 10, 2011

(30) Foreign Application Priority Data
Aug. 7, 2008 (BE) 2008/0437

(51) Int. Cl. G06F 15/16

(52) U.S. Cl. 709/204

(57) ABSTRACT

Eye to Eye system (I2I): Interaction system functioning like a portable, mobile social and dating website.

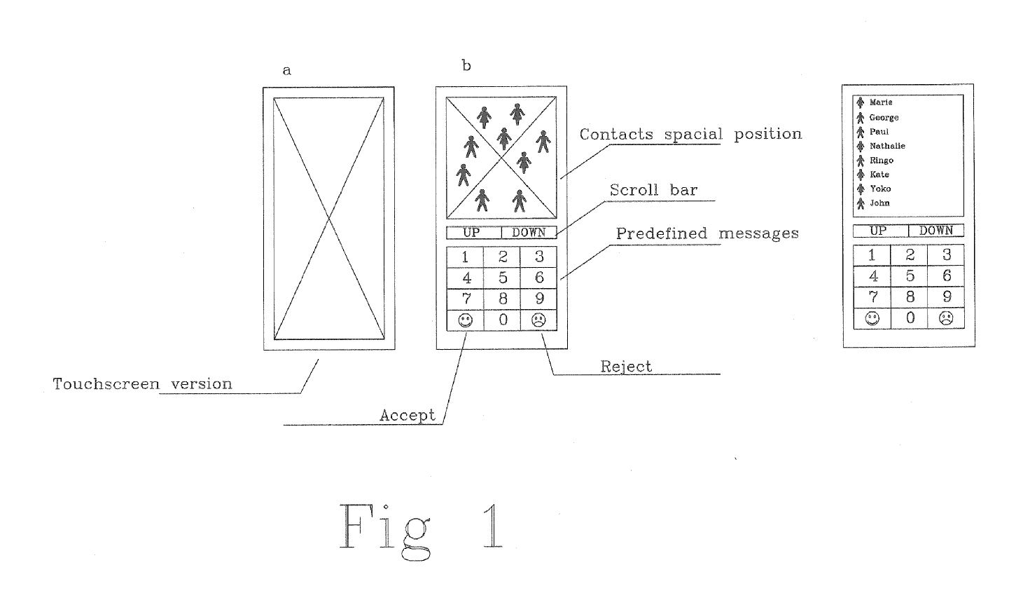

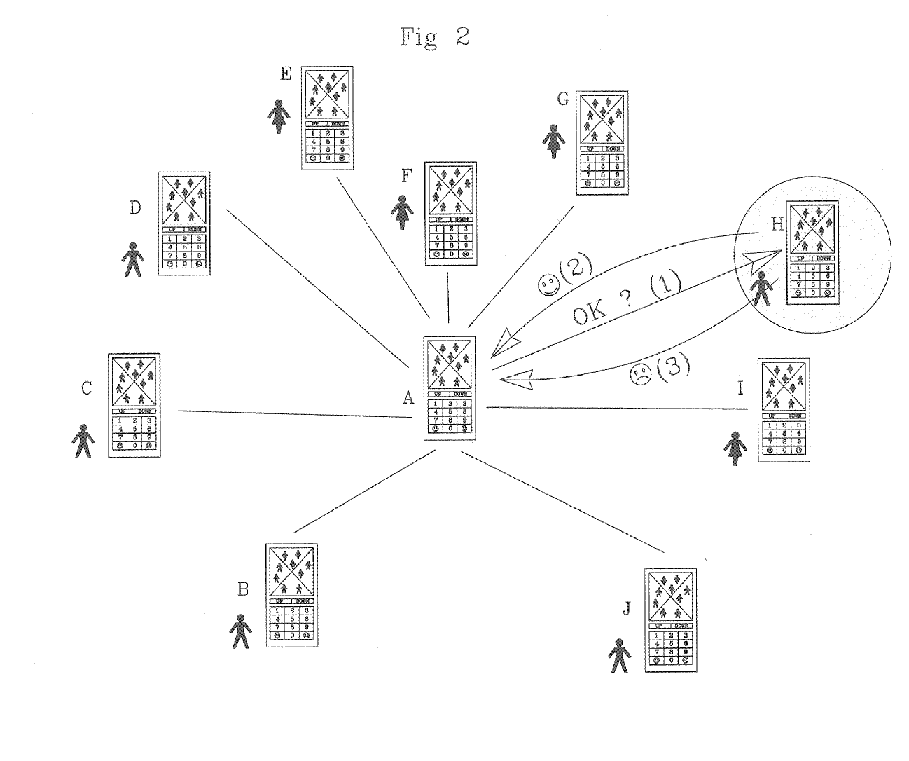

‘Eye to Eye’ system (I2I): interaction system (stand-alone, short-range transmitter-receiver) operating as a portable, mobile social and dating website used to exchange in real time pre-defined icebreaker messages within a 10 m (11 yd) range between two or more users.

User A can see on his/her screen the other users within the device's range. He/she can go through the profiles to find the person he/she is interested in and gets in touch with that person (User H) via pre-defined messages. User H can then elect to either accept or refuse the interaction request.

‘Eye to Eye’ system (I2I)—device which operates as a portable, mobile social and dating network.

Its users can overcome their difficulty in meeting new people by making first exchanges easier.

The invention consists in a portable, mobile case which is a stand-alone, short-range, transmitter-receiver enabling the exchange in real time of predefined messages (encoded during the manufacturing process) within a range of 10 m (11 yd), between two or more users.

When it comes to meeting new faces, people's expectations in most cases are limited to proximity. The advantage of working within sight range is that you therefore avoid unpleasant surprises, which cannot be guaranteed when using the Internet:
No incorrect or intentionally misleading profiles; and
Other users live nearby (and not at the other side of the planet).

Eye to Eye gives its users the guarantee of having in front of them the person they wish to contact as they can actually see him/her.

The invention is therefore a portable, mobile social and dating network that enables its users to exchange a few messages and then meet up if they wish to take the exchange a step further.

The system enables connections based on physical attraction without the use of a computer and an Internet connection; the selection is not operated purely by going through profiles.

Contrary to the Bluetooth system which can manage devices remotely, Eye to Eye limits the exchanges between devices to predefined messages depending on user interest. Consequently, the device can remain visible at all times because there is no possible intrusion (non-invasive operation whereby the user does not come into possession of data enabling him to hack into other systems).

A function to count daily exchanges can be added.

### EXAMPLE

User A is standing in a public or private space (supermarket, nightclub, coffee shop, park . . . ). He/she is surrounded by a dozen people. Eye to Eye shows him/her that 9 people are using a similar device. User A's screen displays the picture of users B, C, D ,E ,F, G, H, I and J.

User A can then compare the pictures on the screen with the surrounding people and can choose the one(s) he wishes to interact with.

User A selects one of the predefined messages (Diagram 2.1). The selected user receives the message in his/her mother-tongue (Diagram 2.2), and can decide either to answer it with one of the predefined messages, or to decline the interaction request (Diagram 2.3).

### Example of Predefined Messages

### Icebreakers

Code 1: Hi!

Code 2: Could I have your number?

Code 3: A stranger is sending you flowers.

Code 4: I find your smile irresistible!

Code 5: May I buy you a drink?

Code 6: What are your plans for the next 30 years?

Code 7: Shall we carry on chatting for real?

### Answering Options

Code 1: Hi!

Code 2: Here is my phone number . . .

Code 3: Thanks!

Code 4: Yes.

Code 5: No.

Code 6: No, thanks.

Code 7: Shall we carry on chatting for real?

### Diagrams Index

### Diagram 1

Portable case with touch screen (a) or keyboard (b)

Case dimensions: 11 cm×6 cm×1 cm/4.3 in×2.4 in×0.40 in

Rechargeable autonomous battery

Colour screen

Pre-defined messages

Option to download other pre-defined messages

Option to connect the device to a computer to download pictures

### Diagram 2

Interaction between User A and the other users

1. Interaction system functioning like a portable, mobile social and dating website.

2. Product Name: ‘Eye to Eye’ system.

3. Product abbreviation: I2I.

4. Product logo:

5. Non-invasive operation whereby the user does not come into possession of data enabling him to hack into other systems; no two-way processing of the device data.

6. Process whereby the user can select other users on the basis of their profile picture

7. The system uses only standard messages provided by the manufacturer (other messages may be downloaded at a later stage but cannot be created so as to guarantee the courtesy of the exchanges).

8. User H receives in his/her own mother-tongue the messages chosen by User A (Diagram 2).
